(19) United States
(12) Patent Application Publication
(10) Pub. No.: US 2024/0111166 A1
(43) Pub. Date: Apr. 4, 2024

(54) MIRROR DEVICE AND VEHICLE DISPLAY DEVICE

(71) Applicant: YAZAKI CORPORATION, Tokyo (JP)

(72) Inventors: Yuki Miyoshi, Makinohara-shi (JP); Yasuhiro Katsumata, Makinohara-shi (JP); Akira Yamanaka, Makinohara-shi (JP); Naoto Tsubakihara, Makinohara-shi (JP); Hiroshi Sano, Makinohara-shi (JP); Tetsuya Suganuma, Shimada-shi (JP); Masaaki Nakamura, Shimada-shi (JP)

(21) Appl. No.: 18/468,672

(22) Filed: Sep. 15, 2023

(30) Foreign Application Priority Data
Sep. 29, 2022 (JP) 2022-155959

(51) Int. Cl. G02B 27/01; G02B 5/08

(52) U.S. Cl. CPC G02B 27/0179; G02B 5/0808; G02B 2027/0145; G02B 2027/0163

(57) ABSTRACT

A mirror device includes a mirror including a main body portion having a reflection surface that reflects display light, and a rotating shaft protruding from a first side wall of the main body portion, and a driving member that includes a motor including an output shaft arranged parallel to the rotating shaft, and neighboring the rotating shaft in a direction orthogonal to a rotation axis line of the rotating shaft, a first gear portion coupled to the output shaft, and a second gear portion engaged with the first gear portion, and coupled to the rotating shaft, and rotates the mirror by transmitting rotation of the output shaft of the motor to the rotating shaft via the first gear portion and the second gear portion.

### CROSS-REFERENCE TO RELATED APPLICATION(S)

The present application claims priority to and incorporates by reference the entire contents of Japanese Patent Application No. 2022-155959 filed in Japan on Sep. 29, 2022.

### BACKGROUND OF THE INVENTION

### 1. Field of the Invention

The present invention relates to a mirror device and a vehicle display device.

### 2. Description of the Related Art

There has conventionally existed a mirror device that reflects display light emitted from a display device of a vehicle display device, toward a reflection member (windshield, etc.) existing in front of a driver of a vehicle. The mirror device includes a mirror, and a driving member that rotates the mirror. Japanese Patent Application Laid-open No. 2000-137189A discloses a headup display device that emits operating information display projected from a display device, in a driver seat direction via a mirror. This headup display device is provided with a reflection unit angle change device as a driving member that changes the angle of a mirror by rotating the mirror.

In a mirror device and a vehicle display device, a reduction in physical size is demanded.

### SUMMARY OF THE INVENTION

The present invention has been devised in view of the above-described circumstance, and aims to provide a mirror device and a vehicle display device that can be reduced in physical size.

In order to achieve the above mentioned object, a mirror device according to one aspect of the present invention includes a mirror including a main body portion having a reflection surface that reflects display light, and a rotating shaft protruding from a side wall of the main body portion; and a driving member that includes: a motor including an output shaft arranged parallel to the rotating shaft and neighboring the rotating shaft in a direction orthogonal to a rotation axis line of the rotating shaft; a first gear portion coupled to the output shaft; and a second gear portion engaged with the first gear portion and coupled to the rotating shaft, and that rotates the mirror by transmitting rotation of the output shaft of the motor to the rotating shaft via the first gear portion and the second gear portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram illustrating a vehicle display device according to an embodiment;

FIG. 2 is a perspective view illustrating a mirror device according to an embodiment;

FIG. 3 is an exploded perspective view illustrating a mirror device according to an embodiment;

FIG. 4 is a cross-sectional view illustrating a mirror device according to an embodiment;

FIG. 5 is a side view illustrating a relationship between a first gear portion and a second gear portion of a mirror device according to an embodiment;

FIG. 6 is a side view illustrating a mirror device according to an embodiment;

FIG. 7 is a perspective view illustrating a vehicle display device according to an embodiment;

FIG. 8 is a perspective view illustrating a vehicle display device according to an embodiment;

FIG. 9 is a perspective view illustrating a vehicle display device according to an embodiment; and

FIG. 10 is a perspective view illustrating a vehicle display device according to an embodiment.

### DETAILED DESCRIPTION OF THE PREFERRED EMBODIMENTS

A mirror device and a vehicle display device according to an embodiment of the present invention will be described in detail below with reference to the drawings. In addition, the present invention is not limited by the embodiment. In addition, components in the following embodiment include the ones easily-conceived by those skilled in the art, or the ones that are substantially identical.

### EMBODIMENT

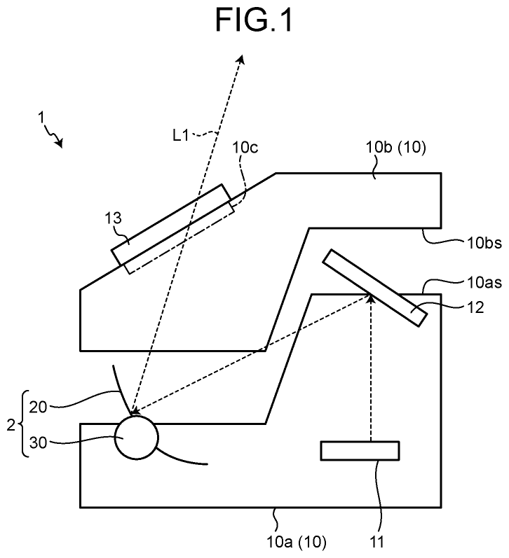

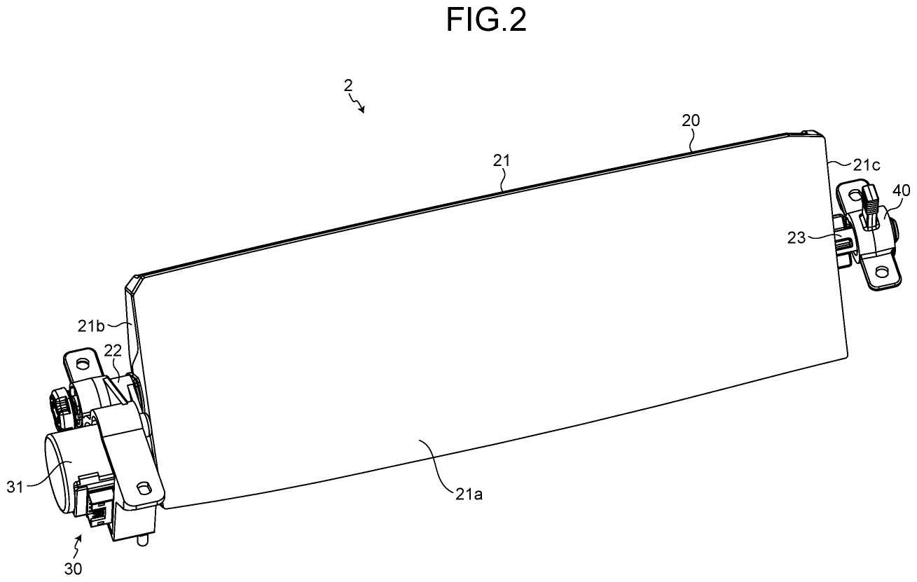

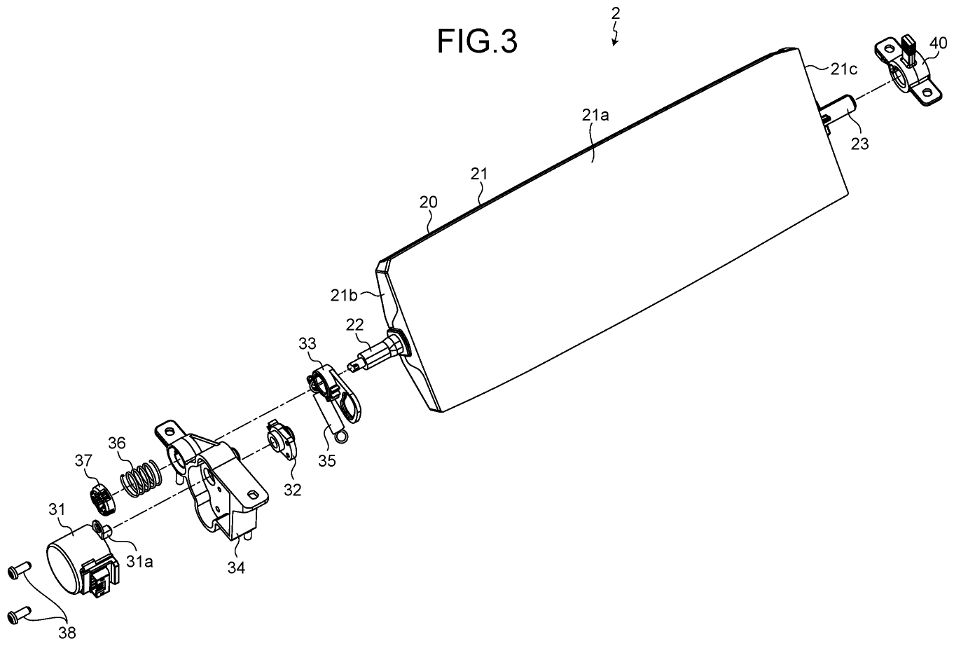

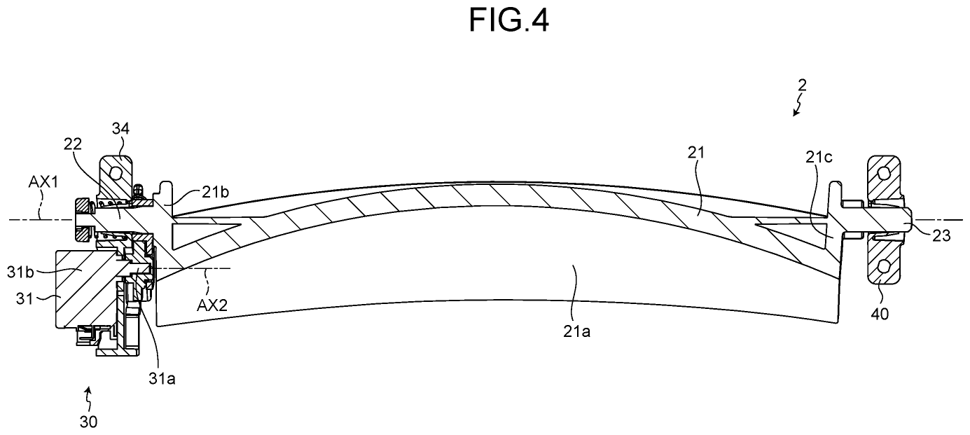

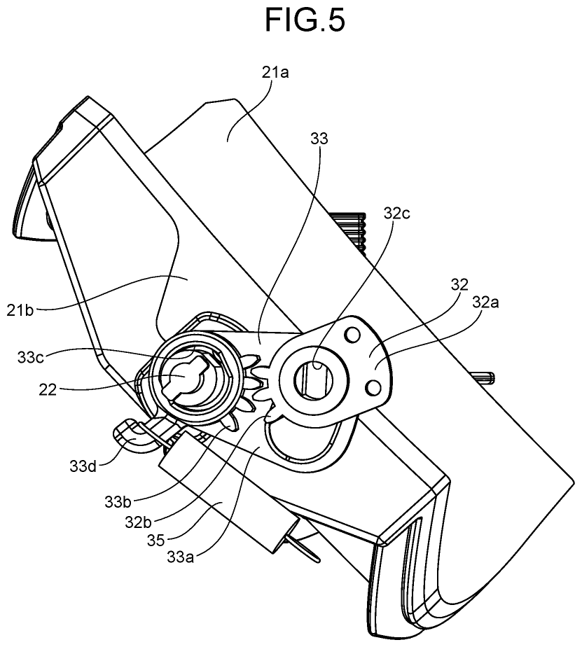

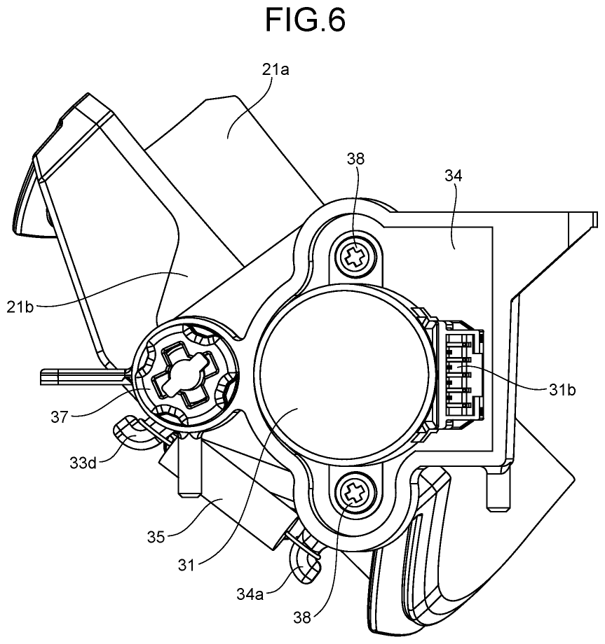

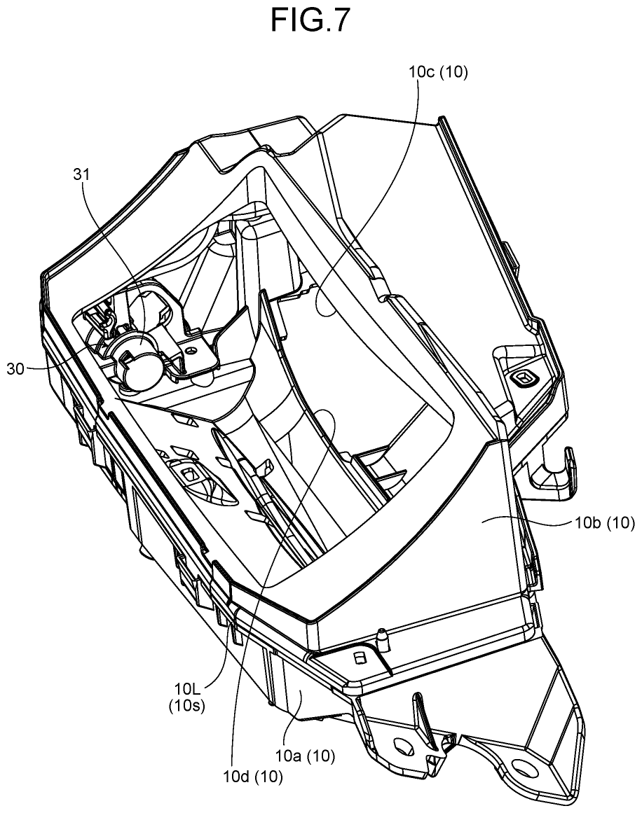

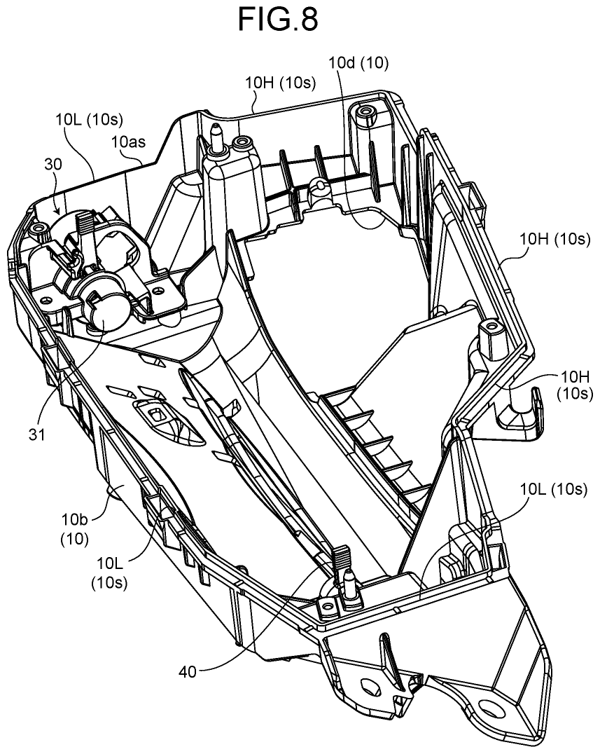

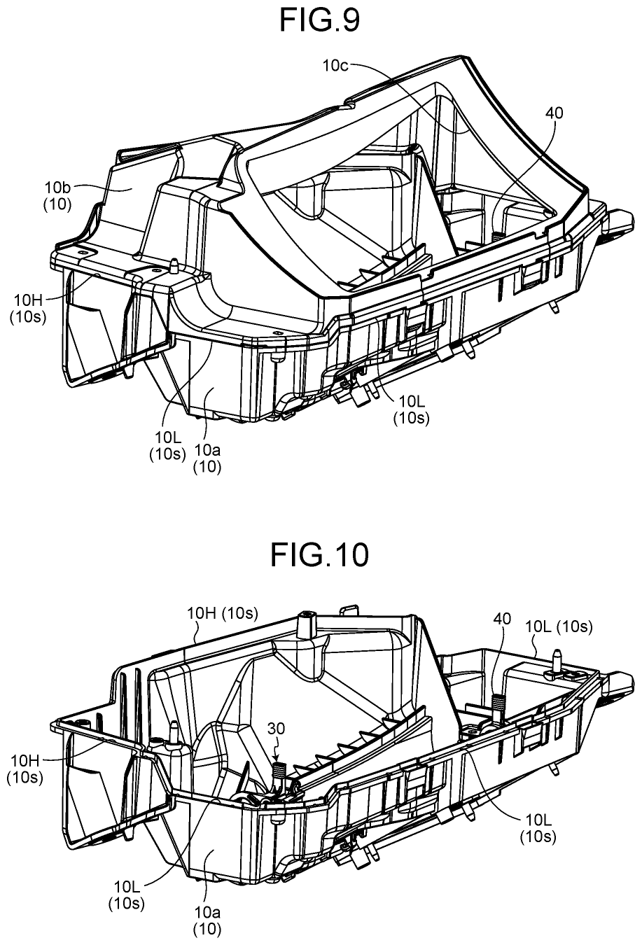

An embodiment will be described with reference to FIGS. 1 to 10. The present embodiment relates to a mirror device and a vehicle display device. FIG. 1 is a schematic configuration diagram illustrating a vehicle display device according to an embodiment, FIG. 2 is a perspective view illustrating a mirror device according to an embodiment, FIG. 3 is an exploded perspective view illustrating a mirror device according to an embodiment, FIG. 4 is a cross-sectional view illustrating a mirror device according to an embodiment, FIG. 5 is a side view illustrating a relationship between a first gear portion and a second gear portion of a mirror device according to an embodiment, FIG. 6 is a side view illustrating a mirror device according to an embodiment, FIG. 7 is a perspective view illustrating a vehicle display device according to an embodiment, FIG. 8 is a perspective view illustrating a vehicle display device according to an embodiment, FIG. 9 is a perspective view illustrating a vehicle display device according to an embodiment, and FIG. 10 is a perspective view illustrating a vehicle display device according to an embodiment.

A vehicle display device 1 illustrated in FIG. 1 is a headup display device mounted on a vehicle such as an automobile. The vehicle display device 1 projects display light L1 of an image toward a windshield. The windshield is a reflection unit positioned in front of an eye point in the vehicle, has semipermeability, for example, and reflects the display light L1 emitted from the vehicle display device 1, toward the eye point. A driver of the vehicle can view a virtual image based on the display light L1 reflected by the windshield.

The vehicle display device 1 according to an embodiment can change an image projected position on the windshield in an up-down direction. The vehicle display device 1 moves an image projected position on the windshield upward or downward based on the position of an eye point, for example. The eye point is a position of an eye of the driver, and is detected using a camera or the like that is provided in the vehicle, for example. The exemplified camera is arranged in a vehicle front portion with respect to the driver seat, and is installed in such a manner that the camera can capture an image of the driver. The eye point is detected by image recognition on an image generated by the camera.

As illustrated in FIG. 1, the vehicle display device 1 includes a mirror device 2, a casing 10, an image display device 11, a planar mirror 12, and a cover member 13. The mirror device 2, the image display device 11, and the planar mirror 12 are provided in the casing 10. The casing 10 is arranged in an instrument panel of the vehicle, for example. The casing 10 has an opening portion 10c at a position facing the windshield. The cover member 13 is a light transmissive member that at least lets through the display light L1 emitted by the image display device 11, and is provided in such a manner as to cover the opening portion 10c of the casing 10.

The image display device 11 outputs a display image to be projected on the windshield, as the display light L1. The image display device 11 includes a liquid crystal display unit and a backlight unit. The liquid crystal display unit is a so-called liquid crystal panel, and includes a transmissive or semi-transmissive thin film transistor (TFT) liquid crystal display, for example. A front side display surface of the liquid crystal display unit emits light by the liquid crystal display unit being illuminated from the back side. The backlight unit illuminates the liquid crystal display unit from the back side. In the embodiment, the backlight unit is arranged with facing the planar mirror 12. The backlight unit is driven by power obtained from a battery (not illustrated) in the vehicle, for example. The vehicle display device 1 according to the embodiment includes a control unit (not illustrated) in the casing 10. By controlling the image display device 11, the control unit performs display control of a display image (virtual image) to be displayed by the vehicle display device 1. Further, the control unit is connected also to the mirror device 2, and controls a display position of the display image by controlling the mirror device 2.

A reflection surface of the planar mirror 12 that reflects the display light L1 is formed into a planar surface, and the planar mirror 12 is arranged at a position facing the image display device 11. The planar mirror 12 reflects the display light L1 emitted from the image display device 11, toward the mirror device 2.

As illustrated in FIG. 2, the mirror device 2 includes a mirror 20, a driving member 30, and a bearing member 40. The mirror 20 reflects the display light L1 reflected by the planar mirror 12, toward the windshield via the opening portion 10c. The mirror 20 of the embodiment is a concave mirror, and has a function as a magnifying mirror. That is, the mirror 20 of the embodiment magnifies and reflects a display image in such a manner that the display image represented by the display light L1 reflected by the concave mirror 20 becomes relatively larger as compared with the display image reflected by the display light L1 before being reflected by the mirror 20.

As illustrated in FIGS. 2 and 3, the mirror 20 includes a main body portion 21 and rotating shafts 22 and 23. The main body portion 21 has a reflection surface 21a that reflects the display light L1. In the embodiment, the main body portion 21 is a substantially rectangular plate member having a shape with a longer direction corresponding to a direction extending along a rotation axis line AX1 (refer to FIG. 4), when viewed from a thickness direction of the main body portion 21.

As illustrated in FIG. 4, the rotating shafts 22 and 23 are arranged at positions on the rotation axis line AX1. The rotation axis line AX1 is a rotational center of the mirror 20. The respective central axis lines of the rotating shafts 22 and 23 exist on the rotation axis line AX1. The rotating shaft 22 protrudes from a first side wall 21b of the main body portion 21 along the rotation axis line AX1. The rotating shaft 23 protrudes from a second side wall 21c of the main body portion 21 along the rotation axis line AX1.

The rotating shaft 22 includes a base end portion and a leading end portion. The base end portion is a portion of the rotating shaft 22 that exists on the base end side, and connects with the first side wall 21b. The shape of the base end portion is a circular cylindrical shape. The leading end portion protrudes from a leading end surface of the base end portion along the rotation axis line AX1. The shape of the leading end portion is a circular cylindrical shape with a diameter smaller than that of the base end portion. At the leading end of the rotating shaft 22, a locking unit protruding toward a radial direction of the leading end portion (direction orthogonal to the rotation axis line AX1) is provided. The locking unit is a portion that locks a spring stopper 37 to be described later.

The shape of the rotating shaft 23 is a circular cylindrical shape. The bearing member 40 to be described later is attached to the rotating shaft 23.

In the mirror 20, the main body portion 21 and the rotating shafts 22 and 23 are integrally molded using synthetic resin. The reflection surface 21a of the main body portion 21 is provided by forming a reflection layer on the surface of the main body portion 21 by vapor deposition or the like.

The driving member 30 includes a motor 31, a first gear portion 32, a second gear portion 33, a motor support portion 34, a first spring 35, a second spring 36, the spring stopper 37, and a screw 38. The motor 31 includes an output shaft 31a and a motor case 31b. The motor 31 rotates the output shaft 31a using power supplied from the battery of the vehicle or the like. Components for rotating the output shaft 31a while consuming the supplied power, such as a rotor and a stator, are accommodated in the motor case 31b. Further, the motor case 31b include a connector for electrically connecting with a control unit or the like. The control unit changes the angle of the mirror 20 by controlling the motor 31 via the connector.

As illustrated in FIG. 5, the first gear portion 32 includes a first base portion 32a and first gear teeth 32b. In the first base portion 32a, a through-hole 32c into which the output shaft 31a of the motor 31 is to be inserted is formed. The first gear portion 32 is coupled to the output shaft 31a in a state in which the output shaft 31a is inserted into the through-hole 32c.

The second gear portion 33 includes a second base portion 33a and second gear teeth 33b. In the second base portion 33a, a through-hole 33c into which the rotating shaft 22 is to be inserted is formed. The second gear portion 33 is coupled to the rotating shaft 22 in a state in which the rotating shaft 22 is inserted into the through-hole 33c.

The first gear teeth 32b of the first gear portion 32 engage with the second gear teeth 33b of the second gear portion 33. The first gear teeth 32b are formed as a plurality of protrusions protruded from the first base portion 32a toward the second gear teeth 33b. The second base portion 33a has a cylindrical projection portion protruding toward the opposite side of the main body portion 21 side of the mirror 20 in such a manner as to surround the through-hole 33c, and the second gear teeth 33b are formed as a plurality of protrusions protruded from the outer circumference of the cylindrical portion toward the first gear teeth 32b. The rotation of the output shaft 31a of the motor 31 is transmitted to the rotating shaft 22 via the first gear portion 32 and the second gear portion 33, and changes the angle of the mirror 20. In the embodiment, a drive gear ratio of the first gear portion 32 and the second gear portion 33 is 1:1, and the mirror 20 can be rotated with almost the same motor torque obtained in a case where a rotating shaft of a mirror is directly connected to an output shaft of a motor. Further, because the drive gear ratio of the first gear portion 32 and the second gear portion 33 is 1:1, the mirror 20 can be rotated at almost the same rotating speed obtained in a case where a rotating shaft of a mirror is directly connected to an output shaft of a motor.

The motor support portion 34 illustrated in FIG. 6 is a member to be fixed in the casing 10 (refer FIGS. 7 and 8) in a state of supporting the motor 31. As illustrated in FIG. 3, the motor support portion 34 is attached to the first gear portion 32 and the second gear portion 33 from the opposite side of the main body portion 21 side of the mirror 20 in such a manner as to cover the first gear portion 32 and the second gear portion 33. The motor support portion 34 includes a first insertion hole into which the rotating shaft 22 is inserted, and a second insertion hole into which the output shaft 31a of the motor 31 is inserted. As illustrated in FIG. 6, the motor 31 is attached to the surface of the motor support portion 34 on the opposite side of the main body portion 21 side of the mirror 20, and fixed to the motor support portion 34 by the screw 38.

As illustrated in FIG. 4, a rotation axis line AX2 of the output shaft 31a of the motor 31 is arranged in such a manner as to be parallel to the rotation axis line AX1 of the rotating shaft 22. The rotation axis line AX2 is a rotational center of the output shaft 31a. The output shaft 31a of the motor 31 is arranged parallel to the rotating shaft 22, and neighbors the rotating shaft 22 in a direction orthogonal to the rotation axis line AX1 of the rotating shaft 22. In the embodiment, the output shaft 31a and a part of the motor case 31b neighbor each other in a direction orthogonal to the rotation axis line AX1 of the rotating shaft 22.

As illustrated in FIGS. 5 and 6, the second base portion 33a of the second gear portion 33 and the motor support portion 34 are respectively provided with hook portions 33d and 34a. The first spring 35 is an expandable coiled spring, and ring portions are provided at both ends. One ring portion of the first spring 35 is attached to the hook portion 33d of the second base portion 33a, and the other ring portion of the first spring 35 is attached to the hook portion 33d of the motor support portion 34. Using contractive force of the spring, the first spring 35 prevents the mirror 20 and the second gear portion 33 from rattling with respect to the motor support portion 34. In other words, the first spring 35 is provided to prevent backlash of the mirror 20 and the second gear portion 33.

As illustrated in FIG. 3, the second spring 36 is an expandable coiled spring. The second spring 36 is attached to the motor support portion 34 in such a manner as to insert the rotating shaft 22 inserted into the first insertion hole of the motor support portion 34, from the opposite side of the main body portion 21 side of the mirror 20 with respect to the motor support portion 34. The spring stopper 37 is attached to the leading end of the rotating shaft 22 in a state in which the rotating shaft 22 is inserted into the second spring 36. The spring stopper 37 is locked by the locking unit formed at the leading end of the rotating shaft 22.

The second spring 36 is attached to the rotating shaft 22 in a contracted state between the spring stopper 37 and the motor support portion 34. A contraction direction of the second spring 36 is a direction extending along the rotation axis line AX1. The second spring 36 applies urging force directed toward the main body portion 21 of the mirror 20, to the motor support portion 34 and the second gear portion 33. The second spring 36 restricts relative movements of the motor support portion 34 and the second gear portion 33 in a direction extending along the rotation axis line AX1, with respect to the mirror 20. In other words, the second spring 36 is provided to prevent backlash of the mirror 20, the motor support portion 34, and the second gear portion 33.

FIGS. 7 to 10 illustrate a state in which the driving member 30 and the bearing member 40 are fixed in the casing 10. In addition, in FIGS. 7 to 10, the illustration of the components other than the driving member 30 and the bearing member 40 that are provided in the casing 10 is omitted, and in FIGS. 8 and 10, the illustration of a lid portion 10b of the casing 10 is further omitted.

As illustrated in FIGS. 7 to 10, the casing 10 includes a box portion 10a with an opened upper part, and the lid portion 10b covering the opening of the box portion 10a. As illustrated in FIGS. 7 and 9, the lid portion 10b includes the opening portion 10c.

As illustrated in FIGS. 8 and 10, the driving member 30 and the bearing member 40 are assembled to the bottom of the box portion 10a. In FIGS. 7 to 10, the illustration of the mirror 20 is omitted, but the driving member 30 and the bearing member 40 are assembled to the box portion 10a in a state of being assembled to the mirror 20. The box portion 10a of the embodiment has a bottom wall portion formed into a substantially rectangular shape, and the driving member 30 and the bearing member 40 are arranged at positions closer to one side in a shorter direction of the bottom wall portion. Further, the driving member 30 and the bearing member 40 are arranged in such a manner as to face each other in a longer direction of the bottom wall portion. On the other side in the shorter direction of the bottom wall portion of the box portion 10a, an opening 10d to which the image display device 11 is attached is formed. In addition, in FIGS. 7 to 10, the illustration of the mirror 20 is omitted, but the mirror 20 is arranged in such a manner that the reflection surface 21a is oriented toward the image display device 11 side.

In the embodiment, a screw insertion hole into which a screw is to be inserted is provided in the motor support portion 34 of the driving member 30. By the screw being attached to the box portion 10a via the screw insertion hole of the motor support portion 34, the driving member 30 is assembled and fixed to the box portion 10a. Further, a screw insertion hole into which a screw is to be inserted is provided also in the bearing member 40 similarly to the motor support portion 34. By the screw being attached to the box portion 10a via the screw insertion hole of the bearing member 40, the bearing member 40 is assembled to the box portion 10a.

The box portion 10a includes a side wall portion installed in a standing manner on the outer periphery of the bottom wall portion in such a manner as to surround the bottom wall portion, and the lid portion 10b includes a side wall portion installed in a standing manner on the outer periphery of a superior wall portion including the opening portion 10c, in such a manner as to surround the superior wall portion. The casing 10 is formed by mating end surfaces 10as and 10bs (refer to FIG. 1) of the respective side wall portions in the box portion 10a and the lid portion 10b. The box portion 10a and the lid portion 10b are fixed using a screw or the like in a state in which the end surfaces 10as and 10bs (refer to FIG. 1) of the respective side wall portions are mated.

In the embodiment, the box portion 10a is formed in such a manner that a height of the side wall portion from the bottom wall portion partially varies. At least a side wall portion around the driving member 30 is formed in such a manner that a height from the bottom wall portion partially becomes lower than heights from bottom wall portions of other side wall portions. In the embodiment, a side wall portion around the mirror device 2 in the box portion 10a is formed in such a manner that a height from the bottom wall portion partially becomes lower than bottom wall portions of other side wall portions.

In other words, in the vehicle display device 1 according to the embodiment, one portion 10L of a mating surface 10s of side wall portions of the box portion 10a and the lid portion 10b is formed at a height position lower than a height position of a different portion 10H of the mating surface 10s. Here, the height position refers to a position in a height direction, and a high height position means that a corresponding position in the height direction is relatively farther from the bottom wall portion of the box portion 10a, and a low height position means that a corresponding position in the height direction is relatively closer to the bottommost position of the bottom wall portion of the box portion 10a. The height direction is a direction orthogonal to a longer direction and a shorter direction of a low wall portion of the box portion 10a. Further, the height direction also corresponds to a direction extending along an assembling direction of the box portion 10a and the lid portion 10b. The one portion 10L of the mating surface 10s that is formed to have a low height position includes a portion neighboring at least the driving member 30. In the embodiment, the one portion 10L is a portion neighboring the mirror device 2. More specifically, the mating surface 10s of side wall portions positioned on the back side of the mirror device 2 (opposite side of the reflection surface 21a side of the mirror 20), the opposite side of the main body portion 21 side with respect to the driving member 30, and the opposite side of the main body portion 21 side with respect to the bearing member 40 is formed at a height position lower than the height position of the different portion 10H. For example, in the embodiment, the height position of the one portion 10L of the mating surface 10s is set to a position lower than an upper end of the driving member 30. By setting a low height position as a height position of the mating surface 10s around the driving member 30 and the mirror device 2, it is possible to prevent side wall portions of the box portion 10a from interfering with a hand of a worker, when the driving member 30 and the mirror device 2 are assembled to the casing 10. Accordingly, assembling workability of the driving member 30 and the mirror device 2 can be enhanced.

Due to a relationship between a draft angle for demolding a box portion when the box portion is molded, and the position of a mating surface, the depth of the box portion becomes deeper as the mating surface gets farther from the bottom of the box portion. For example, in the case of attaching a driving member and a mirror device to a box portion with a deep depth, a handle portion for work has sometimes been formed in the driving member in such a manner that a worker can fix the driving member and the mirror device at predetermined positions in the box portion while holding the driving member with its hand. Because handle portion for work is formed with protruding toward the lid portion 10b side, a vehicle display device sometimes upsizes in the height direction. In the embodiment, because the mating surface 10s around the driving member 30 and the mirror device 2 is formed at a height position lower than that of the different portion 10H, a handle portion for assembling can be omitted, and the vehicle display device 1 can be downsized.

As described above, the mirror device 2 of the present embodiment includes the mirror 20 including the main body portion 21 having the reflection surface 21a that reflects the display light L1, and the rotating shaft 22 protruding from the first side wall 21b of the main body portion 21, and the driving member 30 that includes the motor 31 including the output shaft 31a arranged parallel to the rotating shaft 22, and neighboring the rotating shaft 22 in a direction orthogonal to the rotation axis line AX1 of the rotating shaft 22, the first gear portion 32 coupled to the output shaft 31a, and the second gear portion 33 engaged with the first gear portion 32, and coupled to the rotating shaft 22, and rotates the mirror 20 by transmitting rotation of the output shaft 31a of the motor 31 to the rotating shaft 22 via the first gear portion 32 and the second gear portion 33.

By arranging the output shaft 31a of the motor 31 in such a manner as to be parallel to the rotating shaft 22, and. Neighbor the rotating shaft 22 in a direction orthogonal to the rotation axis line AX1 of the rotating shaft 22, a size in a width direction of the mirror device 2 can be reduced. For example, as compared with a configuration in which an output shaft of a motor and a rotating shaft of a mirror are arranged in a direction extending along a rotation axis line of the mirror, and directly connected, the mirror device 2 of the embodiment can reduce a size in the width direction (direction extending along the rotation axis line AX1).

Further, the vehicle display device 1 of the present embodiment includes the casing 10 including the opening portion 10c, the image display device 11 that is provided in the casing 10, and outputs the display light L1 of an image, and the mirror device 2 provided in the casing 10, and the mirror device 2 includes the mirror 20 including the main body portion 21 having a reflection surface 21a that reflects the display light L1, and the rotating shaft 22 protruding from the first side wall 21b of the main body portion 21, and the driving member 30 that includes the motor 31 including the output shaft 31a arranged parallel to the rotating shaft 22, and neighboring the rotating shaft 22 in a direction orthogonal to the rotation axis line AX1 of the rotating shaft 22, the first gear portion 32 coupled to the output shaft 31a, and the second gear portion 33 engaged with the first gear portion 32, and coupled to the rotating shaft 22, and rotates the mirror 20 by transmitting rotation of the output shaft 31a of the motor 31 to the rotating shaft 22 via the first gear portion 32 and the second gear portion 33.

By arranging the output shaft 31a of the motor 31 in such a manner as to be parallel to the rotating shaft 22, and. Neighbor the rotating shaft 22 in a direction orthogonal to the rotation axis line AX1 of the rotating shaft 22, a size in a width direction of the mirror device 2 can be reduced, and a size in the width direction of the vehicle display device 1 can also be reduced.

Further, in the vehicle display device 1 of the present embodiment, the casing 10 includes the box portion 10a with an opened upper part, and the lid portion 10b covering the opening of the box portion 10a and including the opening portion 10c, and on the mating surface 10s of the box portion 10a and the lid portion 10b, the one portion 10L of the mating surface 10s is formed at a height position lower than a height position of the different portion 10H of the mating surface 10s, and the one portion 10L of the mating surface 10s includes a portion neighboring at least the driving member 30.

By forming the mating surface 10s around the driving member 30 to partially have a low height position in the mating surface 10s of the box portion 10a and the lid portion 10b, it is possible to enhance assemblability of the driving member 30 with respect to the box portion 10a. Further, by setting a low height position as a height position of the mating surface 10s around the driving member 30, a depth of a portion of the box portion 10a in which the driving member 30 is accommodated can be made shallow. In the vehicle display device 1 according to the embodiment, because a depth of a portion of the box portion 10a in which the driving member 30 is accommodated can be made shallow, for example, a handle portion can be omitted, and the vehicle display device 1 can be downsized.

The matters disclosed in the above-described embodiment can be executed while being appropriately combined.

Because the mirror device and the vehicle display device according to the present embodiment have the above-described configuration, such an effect that their physical sizes can be reduced is caused.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mirror device comprising:
a mirror including a main body portion having a reflection surface that reflects display light, and a rotating shaft protruding from a side wall of the main body portion; and
a driving member that includes: a motor including an output shaft arranged parallel to the rotating shaft and neighboring the rotating shaft in a direction orthogonal to a rotation axis line of the rotating shaft; a first gear portion coupled to the output shaft; and a second gear portion engaged with the first gear portion and coupled to the rotating shaft, and that rotates the mirror by transmitting rotation of the output shaft of the motor to the rotating shaft via the first gear portion and the second gear portion.

2. A vehicle display device comprising:
a casing including an opening portion;
an image display device that is provided in the casing and outputs display light of an image; and
a mirror device provided in the casing, wherein
the mirror device includes:
a mirror including a main body portion having a reflection surface that reflects display light, and a rotating shaft protruding from a side wall of the main body portion; and
a driving member that includes a motor including an output shaft arranged parallel to the rotating shaft and neighboring the rotating shaft in a direction orthogonal to a rotation axis line of the rotating shaft, a first gear portion coupled to the output shaft, and a second gear portion engaged with the first gear portion and coupled to the rotating shaft, and that rotates the mirror by transmitting rotation of the output shaft of the motor to the rotating shaft via the first gear portion and the second gear portion.

3. The vehicle display device according to claim 2, wherein
the casing includes a box portion with an opened upper part, and a lid portion covering the opening of the box portion and including the opening portion,
on a mating surface of the box portion and the lid portion, one portion of the mating surface is formed at a height position lower than a height position of a different portion of the mating surface, and
the one portion of the mating surface includes a portion neighboring at least the driving member.
